(19) United States
(12) Patent Application Publication
(10) Pub. No.: US 2011/0303184 A1
(43) Pub. Date: Dec. 15, 2011

(54) Internal combustion engine

(76) Inventor: Usher Meyman, Brooklyn, NY (US)

(21) Appl. No.: 12/802,634

(22) Filed: Jun. 11, 2010

(51) Int. Cl. F02B 53/00

(52) U.S. Cl. 123/242

(57) ABSTRACT

A Wankel-type rotary engine comprising a longitudinal housing divided on two parts by a partition having a window, a rotor passed through the window and engaged with an end wall sliding in the cavity, and forming together with the cavity, end wall and partition working chambers, and a means for moving the rotor along the cavity.

### BACKGROUND OF THE INVENTION

The invention relates to an internal combustion engine and more particularly to the Wankel type rotary engine.

No internal combustion engine, which could develop a torque proportionally to loading moments, is known in the art. Further, even the latest Mazda's rotary engines have problems with seals and proper combustion of fuel. Accordingly, the objects of the present invention are to provide an engine which is able to change its torque automatically and proportionally to a load, and to solve sealing and combustion problems. The invention is based in particular on principle of the Wankel type rotary engine. Besides that, the inventive engine, especially of three-lobed cavity version, is able more successfully than any known engine, to adopt the new engine cycle disclosed in patent application Ser. No. 12/658,705, because it is naturally does for utilization two (of six) strokes for preliminary heating and additionally mixing the air-fuel charge. The invention will be understood from the following description and drawings.

### BRIEF DESCRIPTION OF THE DRAWINGS

FIGS. 1 to 3 are mechanical diagrams of the engine in accordance with the invention.

FIG. 4 is a schematic view of arrangement of working cavities.

FIG. 5 is a longitudinal section of the engine with a scheme of a flow circuit.

FIGS. 6 to 24 are fragmentary sectional views of the engine in the different scales.

### DESCRIPTION OF PREFERRED EMBODIMENTS

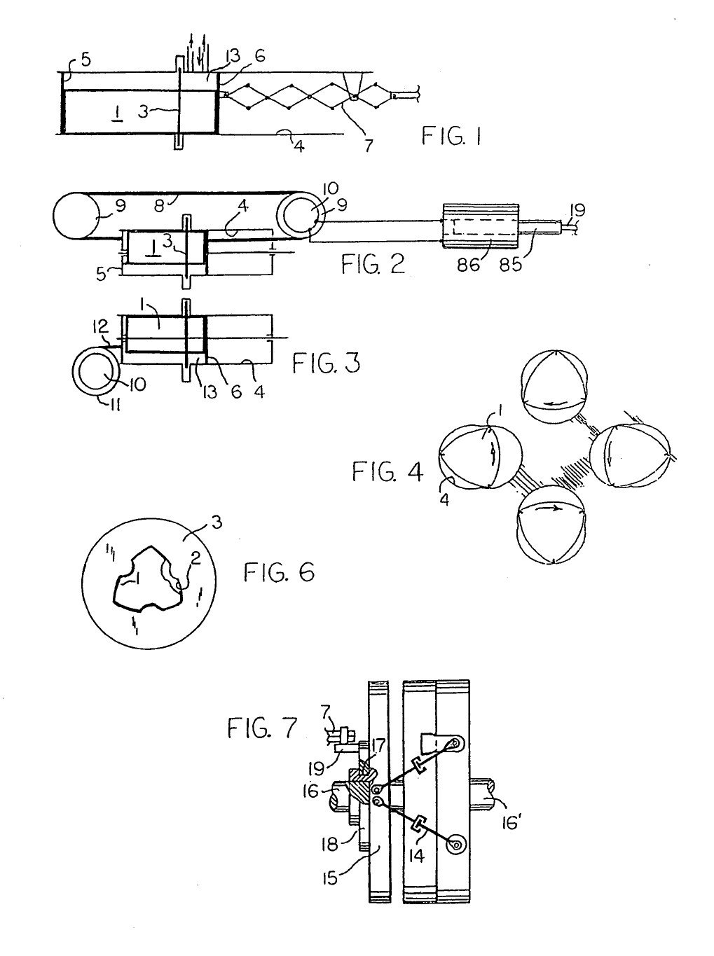

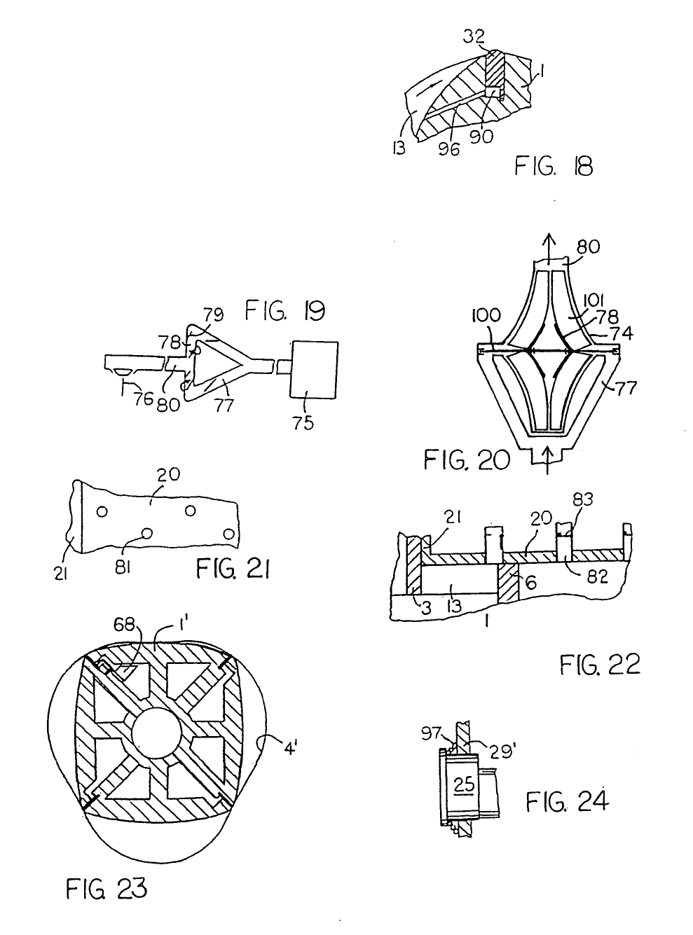

The new principle of operation of the inventive engine is understood from FIG. 1. A rotor 1 passed through an opening 2 (FIG. 6) in a partition 3 and rotating together with the latter, slides along a cavity 4 together with a support 5 and an end wall 6 the contour of which coincides with the contour of cavity 4. The position of rotor 1 along cavity 4 depends on the length of a parallel link mechanism 7 connected with end wall 6. When the length of mechanism 7 changes, the rotor shifts, area of its working surfaces (faces) between end wall 6 and partition 3 changes also, and, consequently, the torque of the engine changes. A means for moving the rotor along cavity 4 may consist of a chain 8 (FIG. 2) engaged with sprockets 9 one of which is fixed on a shaft of a servomotor 10. Otherwise, the latter (FIG. 3) provided with a drum 11 having a rope 12, either pulls the rotor to the left, or lets pressure in combustion chamber 13 to push end wall 6 with the rotor to the right. Any suitable conventional device intended for measuring the torque or load may be used for sending corresponding signals to the servomotor.

FIG. 7 shows a coil clutch having pairs of compound turning rods 14 engaged with a disk 15. Disk 15 sliding along an output shaft 16, has a neck 17 in which a non-rotatable pusher 18 is installed. Pusher 18 has an extension 19 connected with link mechanism 7. When the load on a shaft 16′ increases, coils of the clutch contract, the ends of rods 14 mounted on the clutch draw together, the opposite ends of the rods shift disk 15 with pusher 18 to the left and extension 19 urges link mechanism 7 to shorten, i.e. to move rotor 1 to the right. Extension 19 may be connected with a core 85 (FIG. 2) of a sensitive solenoid 86 which sends signals to servomotor 10 depending on direction of shifting the core, i.e. on changing loads on shaft 16′. If load does not change, then core 85 does not move and the signals do not appear.

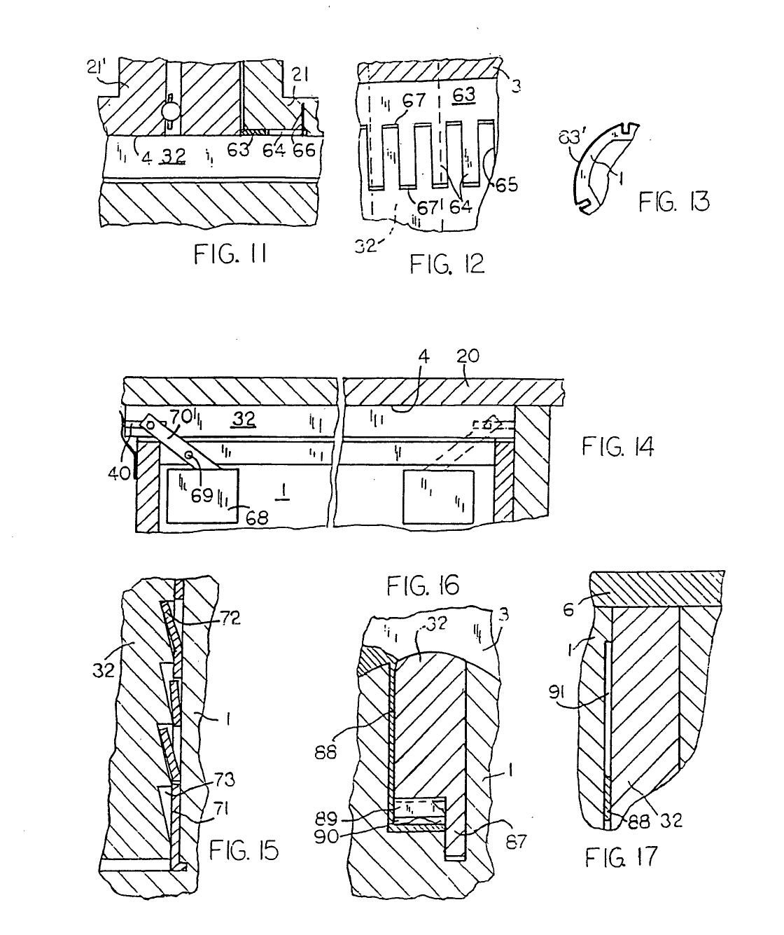

An engine in accordance with the new mechanical diagram (FIG. 5) has a housing 20 consisting of two parts connected with one another by flanges 21 and 21′ and closed at both sides by covers 5′. Rotor 1 is mounted on eccentrics 25 and 25′ which may be made integral with a balance mass 26 and are rotatable accordingly in end wall 6 and in an externally toothed gear 27 fixed in support 5. (The balance masses may be installed traditionally outside of the rotor). The stiffness of the long rotor may be reached by means described hereinafter. The synchronizing gearing (which may be installed at both sides of the rotor) consists of gear 27 and an internally toothed gear 28 fixed to a side wall 29 of rotor 1 having also an opposite side wall 29′. Eccentric 25 having at least one key 30 may slide along output shaft 16 having the same number of longitudinal slots 31. Apex seals 32 biased by springs 33 against end wall 6, are replaceable through windows 34 opened for tune-up.

It is very important that, while the unit pressure on end wall 6 and partition 3 drops sharply during working stroke, their areas which are under pressure, increase also sharply. Therefore the axial forces pressing on end wall 6 and partition 3 change smoothly and act constantly. The following solutions take this into account.

A means for eliminating clearance between flange 21 and partition 3 may consist of a ring 22 (FIGS. 5 and 8) having a plurality of transverse slots 22′, and a disk 23 resting on balls 24 of a bearing case and having a plurality of centrifugal pawls 35 mounted in gradually differing position and engaged with the slots of ring 22. Disk 23 has pins 36 engaged with a spiral groove 37 of ring 22 (or vice versa). Alternatively, threads may be used. Springs 38 urge pawls 35 to turn ring 22, and the latter, therefore, presses partition 3 to flange 21. When ring 22 and disk 23 rotate together with rotor 1, each pawl 35 turns counterclockwise and completely disengages ring 22, but at least one of a plurality of pawls 35′ mounted in gradually differing position on disk 23, holds ring 22 in the initial position. After elementary wear of partition 3 and/or flange 21, at least one other pawl 35 will be ready to engage ring 22 and to turn the latter (after stop) and, therefore, to press the partition 3 to the flange with the minimal (designed) force.

A means for moving rotor 1 along cavity 4 may be constituted from a hydraulic system in which coolant fills up the engine between the left cover 5′ and a telescopic cylinder (circular, oval, etc) 50 and also rotor 1 and a space between support 5 and partition 3. Partition 3 having a plurality of blades 39 and 39′ and rotor 1 rotating commonly pump coolant. As soon as load is applied to a shaft 16′, a sensor 42 responding to pressure (or solenoid 86, if it is used instead of sensor 42) sends signals to servomotor 10 which turns a butterfly 43 of a valve 44 clockwise, holds it in this position until the load increases, and the coolant flows through a tube 45 into a space between the left cover 5′ and support 5 and pushes the latter with rotor 1 to the right. The volume of a space 47 between support 5 and partition 3 decreases, and coolant leaves it into a lengthening telescopic cylinder 48 (FIG. 9). End wall 6 moving to the right, shortens cylinder 50, and coolant leaves it through a tube 51, valve 44, a tube 52 and several windows 49 and 49′ in disk 23 (which are not on the trajectory of balls 24) into a space between the flanges. When load decreases, servomotor 10 turns butterfly 43 counterclockwise, holds it in this position until the load decreases, and coolant flows through tube 51 into cylinder 50 and pushes end wall 6 and the rotor to the left. Coolant displacing from the decreasing space between the left cover 5′ and support 5, flows through tube 45, valve 44 and tube 52 into the space between the flanges and also leaves shortening cylinder 48 into increasing space 47. If load is not changing, servomotor 10 does not receive signals and butterfly 43 returns in the horizontal position and stay in this position until the load begins to change again. Cylinder 50 is shifted down towards combustion chamber 13 for neutralization of internal pressure on end wall 6 and skewing of the latter.

Independently on operation mode of the engine, coolant is discharging through a tube 54 into cooler 41, and then flows into a cooling jacket 55. After that, coolant returns into the space between the flanges through a tube 56. Another portion of coolant leaving cooler 41 flows through a tube 57, a multi-link tube 58, a hole 59 in end wall 6, a space inside of a ring 60 biased against end wall 6, and holes 61 in side wall 29′ into rotor 1. Then, cooled the latter, it flows through holes 62 in side wall 29 into space 47. Coolant may enter the rotor also through holes 59′ or only through holes 59′, then, tubes 57 and 58 will be unnecessary, all the more if cooler 41 is installed before (not shown) valve 44. To compensate difference in changing volumes of coolant, an empty telescopic cylinder 46 may be installed between the left cover 5′ and support 5. Besides that, the volume of any cylinder changes differently depending on which its elements (having different diameter) move at a given moment, which helps to equalize the increasing and decreasing volumes, especially if the length of the cylinders is some greater than the maximal axial displacement of the rotor. Partition 3 may be provided with elastic inserts 84 which are close to coolant. Partitions 53 slightly biased against apex seals 32 prevent pressure of coolant to penetrate under the seals.

Preliminary provided suitable pressure of coolant biases the rotor against end wall 6 and partition 3 against flange 21 (overcoming pressure in combustion chamber), therefore no side seals, ring 22 and disk 23 with the pawls are needed at all. Partition 3 may be provided with several centrifugal springs 99 (FIG. 10) biasing the latter against flange 21 and preventing filling coolant from penetration into working chambers, but not contacting flange 21′ after start of the engine.

Depressions in the partition, inlets and outlets in flange 21 (not shown) which may be provided for gas exchange (and for cross-over of the mixture into intermediate chamber in an engine with three-lobed cavity) and cut-outs in neutral zones lessen the friction areas. Still essential friction is justified by simplicity and other advantages of the engine. Otherwise, an edge 98 (FIG. 10) provided on flange 21 minimizes friction (also in a version without a hydraulic system).

Since the engine is filled up with coolant, it is heated almost uniformly, which diminishes requirements for coefficient of volumetric expansion of its parts. Therefore, the long rotor may be made of any suitable durable material and will be stiff especially as it is intensively cooling. Vibration dumper and pressure regulator may be provided. The hydraulic system may be used only for cooling or only for moving the rotor. A pump may be installed outside the housing.

A spring 97 (FIG. 24) installed between eccentric 25 (or 25′) and side wall 29′ (or 29), biases the rotor against end wall 6 eliminating necessity of the side seals.

A seal between partition 3 and flange 21 may represent a rim 63 (FIG. 11) inside surface of which coincides with cavity 4. It has a plurality of narrow keys 64 (FIG. 12) engaging grooves 65 in flange 21, and biased against partition 3 by some springs 66 installed in suction and exhaust zones. After a long period of operation time of the engine, the trifling amount of the medium will leak into adjacent chamber through one of appeared slots 67 only at a moment, when apex seal 32 (shown conditionally by dash lines) overlaps this slot. Similar rim 63′ (FIG. 13) with wider keys may be provided on rotor 1 at end wall 6 instead of the regular side seals.

Centrifugal forces retaining seals 32 against the surface of cavity 4 (FIG. 14) may be balanced by counterweights 68 mounted in rotor 1 on axles 69 and engaged with slots 40 in seal 32 by levers 70. Then, friction losses and wear of seals 32 and the surface of cavity 4 will be practically eliminated. To prevent the apex seals from shifting towards axis of the rotor by pressure on their open arc-shaped surface, the rotor (or seals 32) may be provided with strips 71 (FIG. 15) so that at least some of a plurality of their pawls 72 located in gradually differing positions, are engaged with at least one of a plurality of shallow longitudinal slots 73 on seal 32 (or on rotor). Otherwise, seals 32 may be provided with a longitudinal rib 87 (FIG. 16) while partition 3 is provided with legs 88 carrying a biased insert 89. Pressure of combusting gas penetrating in a space 90 through a longitudinal slit 91 (FIG. 17) counteracts to pressure on the open portion of the arch-shaped surface of seal 32, but may not penetrate behind legs 88.

The traditional Wankel rotary engines may be provided with counterweights 68 together either with strip 71 and slots 73 shown in FIG. 15, or with conduits 96 (FIG. 18) communicating space 90 with combustion chamber 13.

The engine may be provided with an air-fuel mixer (FIG. 19) installed between a carburetor 75 and an intake system having a suction valve 76 or an intake port of a rotary engine and having two or more sleeves 77 separating the flow and having spiral ribs 79. The ends of sleeves 77 are directed towards each other, and the ribs twirl the contrary flows in the opposite directions. As a result, the flow in an outlet pipe 80 becomes more homogeneous. Turbines 78 (FIG. 20) may be installed between sleeves 77 in a housing 74 on an axle 100. Since blades 101 of the turbines are curved in the opposite direction, suctioning mixture rotates them in the opposite direction improving condition of agitation. The mixer may have two or more such consecutive stages. Increased resistance to suction is justified by a better combustion of fuel, i.e. by higher efficiency and lessened toxic fumes.

Some additional spark-plugs 81 (FIG. 21) may be installed along housing 20. The engine may be provided with additional inlets 82 (FIG. 22). Each next check valve 83 of the inlet becomes open by suctioning mixture after end wall 6 passes it.

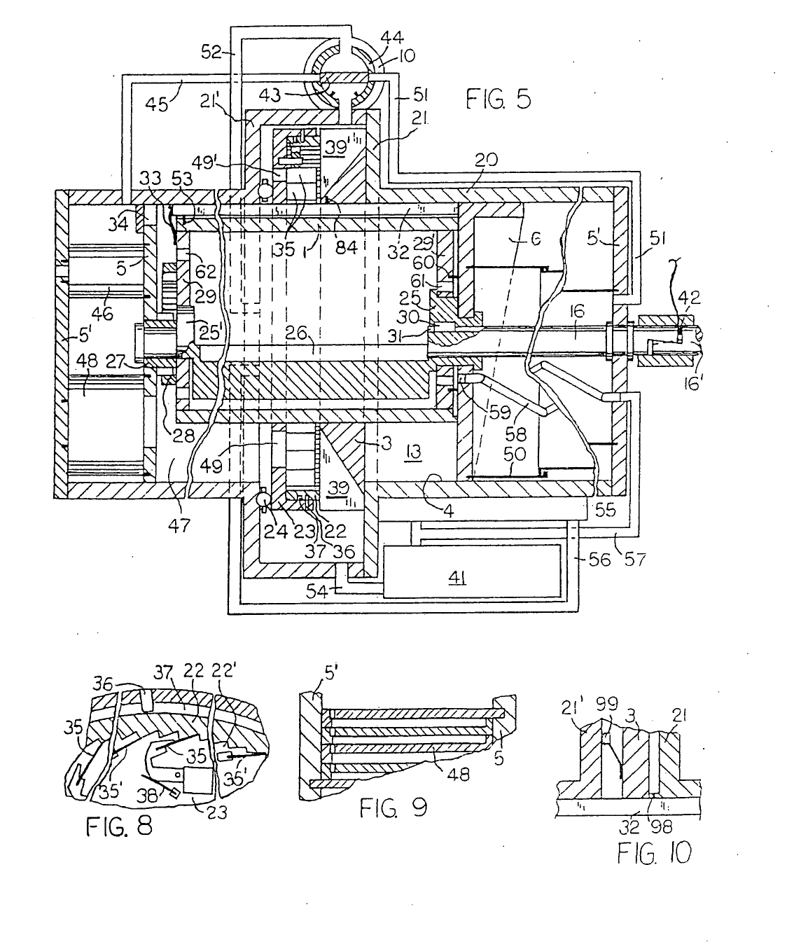

Absence of an automatic transmission increases the effective efficiency of a power unit at about 15%. Conformity between the load and torque eliminates need in a heavy flywheel. The engine having four parallel rotors (FIG. 4) rotating symmetrically, is balanced without masses 26 and, therefore, especially if it has three-lobed cavities 4′ (FIG. 23), its rotors 1′ may be made stiff enough (only one centrifugal mass 68 is shown). As a result, the specific power of the power unit essentially increases and fuel consumption lessens which gives off less toxic fumes into the environment for the same job.

The invention is not limited to the details shown since various modifications and structural changes are possible without departing in any way from the spirit of the present invention.

What is claimed is:

1. An internal combustion engine, comprising a housing having at least one cavity and consisting of two aligned parts having flanges connected with one another and forming a space; a partition having a window and installed in said space; a support and an end wall installed in said cavity; a shaft aligned with said cavity; eccentrics disposed rotatably in said support and end wall and at least one of which has at least one key and installed on said shaft hawing at least one longitudinal slot cooperating with said key; a rotor having side walls, passed through said window, mounted on said eccentrics and forming together with said cavity, end wall and partition working chambers; at least one synchronizing gearings having an inner gear fixed to said side wall and an outer gear fixed on at least one part of a row containing said support and end wall; means for moving said rotor along said cavity; and means for sealing said working chambers.

2. The internal combustion engine as defined in claim 1, wherein said means for moving said rotor consists of a chain connected with said end wall and support, sprockets engaged with said chain and a servomotor connected with said sprocket.

3. An internal combustion engine, comprising a rotor with apex seals and further comprising centrifugal counterweights mounted on said rotor and engaged with said apex seals.

4. An internal combustion engine, comprising a carburetor and an intake system and further comprising an air-fuel mixer installed between said carburetor and intake system.

5. The internal combustion engine as defined in claim 4, wherein said mixer consists of at least two sleeves separating the flow of air-fuel mixture and having spiral ribs and ends directed towards each other and connected with an outlet.
